(19) United States
(12) Patent Application Publication
(10) Pub. No.: US 2026/0301717 A1
(43) Pub. Date: Oct. 1, 2026

(54) STRINGS FOR MUSICAL INSTRUMENTS

(71) Applicant: W. L. Gore & Associates, Inc., Newark, DE (US)

(72) Inventors: John Anthony Galvis, Newark, DE (US); Carter James Morris, Newark, DE (US)

(73) Assignee: W. L. Gore & Associates, Inc., Newark, DE (US)

(21) Appl. No.: 19/632,824

(22) Filed: Mar. 30, 2026

Related U.S. Application Data
(60) Provisional application No. 63/780,683, filed on Mar. 31, 2025.

(51) Int. Cl. G10D 3/10; C09D 171/00

(52) U.S. Cl. CPC G10D 3/10; C09D 171/00

(57) ABSTRACT

A string of a musical instrument comprises an elongate body including a core and a winding secured around the core, wherein the elongate body is characterized by a tonal quality having a first value; and a polymer cover containing at least 95 wt. % of a poly(ether ketone ketone) (PEKK) polymer, the PEKK polymer at least partially covering an outer surface of the winding such that the tonal quality of the elongate body is characterized by a second value.

### BACKGROUND

There are a multitude of different types of musical strings employed today, each performing a different function. A typical guitar employs a straight (non-wound) string (such as “gut,” metal, or synthetic polymer (e.g., those disclosed in U.S. Pat. Nos. 4,339,499 and 4,382,358)) for higher pitched notes, and wound metal or polymer strings (usually a wrapped metal or polymer winding over a core of metal, nylon or similar material) for lower pitched notes. Wound strings rely on the additional string mass per unit length supplied by the spiral wrap of the wound string to supply lower pitched notes at an acceptable string tension. Existing string designs have been refined over many years to provide excellent musical tones, but the strings continue to be limited in many respects.

For example, wound strings on stringed musical instruments (e.g., guitar, violin) require human contact along at least a portion of the strings, and may become contaminated with dirt, skin oils, and/or perspiration after even a few hours of playing. The dirt and other contaminants infiltrate windings of the string and may cause the windings to have limited motion and eventually become musically “dead” after a relatively short period of play time due to the build-up of this contamination. Wound strings that lose their tonal qualities must be removed from the instrument and replaced. This process is burdensome, time consuming, and expensive for musicians who play frequently and care about tonal quality.

Thus, there remains a need for increasing the durability of strings while preserving their tonal qualities.

### SUMMARY

According to one aspect, (“Aspect 1”), a string of a musical instrument comprises an elongate body including a core and a winding secured around the core, wherein the elongate body is characterized by a tonal quality having a first value; and a polymer cover containing at least 95 wt. % of a poly(ether ketone ketone) (PEKK) polymer, the PEKK polymer at least partially covering an outer surface of the winding such that the tonal quality of the elongate body is characterized by a second value.

Aspect 2 is the string of Aspect 1, wherein the polymer cover has a shape substantially similar to the shape of the winding.

Aspect 3 is the string of Aspect 1, wherein the polymer cover has a shape dissimilar to the shape of the winding.

Aspect 4 is the string of Aspect 1, wherein the polymer cover is applied to the winding after the winding is secured around the core.

Aspect 5 is the string of Aspect 1, wherein the polymer cover is applied to the winding prior to the winding being secured around the core.

Aspect 6 is the string of Aspect 1, wherein the polymer cover modifies the tonal quality of the elongate body such that the second value is substantially dissimilar from the first value.

Aspect 7 is the string of Aspect 1, wherein the first value and the second value have similar signal amplitudes at frequencies from about 4,000 Hz to about 20,000 Hz and the tonal quality of the elongate body is not substantially damped.

Aspect 8 is the string of Aspect 1, wherein the polymer cover enhances an acoustic bandwidth of the elongate body.

Aspect 9 is the string of Aspect 1, wherein the polymer cover preserves the tonal quality of the elongate body without substantially changing the first value.

Aspect 10 is the string of Aspect 1, wherein the polymer cover substantially changes the tonal quality of the first value.

Aspect 11 is the string of Aspect 1, wherein the polymer cover is substantially non-damping to the tonal quality of the elongate body.

Aspect 12 is the string of Aspect 1, wherein the polymer cover changes the damping in a controlled manner.

Aspect 13 is the string of Aspect 1, wherein the polymer cover protects the elongate body from corrosion.

Aspect 14 is the string of Aspect 1, wherein the polymer cover at least partially covers the winding without use of an adhesive between the winding and the polymer cover.

Aspect 15 is the string of Aspect 1, wherein the polymer cover has a thickness from about 1 micron to about 30 microns.

According to one aspect, (“Aspect 16”), a method comprises providing a string of a musical instrument, the string having a first elongate body including a core and a winding around the core, wherein the elongate body is characterized by a tonal quality having a first value; at least partially covering the winding with a poly(ether ketone ketone) (PEKK) polymer to form a second elongate body; and heating the second elongate body to a temperature from about 200° C. to about 400° C. to secure the PEKK polymer onto the winding and form a second elongate body characterized by a tonal quality having a second value.

Aspect 17 is the method of Aspect 16, wherein the polymer cover is substantially non-damping to the tonal quality of the elongate body.

Aspect 18 is the method of Aspect 16, wherein the polymer cover enhances an acoustic bandwidth of the elongate body.

Aspect 19 is the method of Aspect 16, wherein the polymer cover on the second elongate body has a thickness from about 1 micron to about 30 microns.

Aspect 20 is the method of Aspect 16, comprising applying the polymer cover to the winding after the winding is secured around the core.

Aspect 21 is the method of Aspect 16, comprising applying the polymer cover to the winding prior to the winding being secured around the core.

According to one aspect (“Aspect 22”), a string of a musical instrument comprises a core; a winding secured around the core; and a polymer cover containing at least 95 wt. % of a poly(ether ketone ketone) (PEKK) polymer.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a three-quarter perspective view of an acoustic guitar in accordance with some embodiments.

FIG. 2 is a three-quarter isometric view, partially in cut-away, of a covered string construction in accordance with some embodiments.

FIG. 3 is a transverse cross-section view along line 3-3 of FIG. 2 in accordance with some embodiments.

FIG. 4 is a side view of a portion of an uncovered metal string in accordance with some embodiments.

FIG. 5 is a side view of a portion of a string including a polymer cover forming a shape around the wound string dissimilar to the shape of the winding in accordance with some embodiments.

FIG. 6 is a side view of a portion of a string including a polymer cover forming a shape around the wound string similar to the shape of the winding in accordance with some embodiments.

FIG. 7 shows means of Average Change in Roughness (change in Ra_{avg}) data collected and calculated in accordance to the Pick-O Test Method for Example 1, Example 2, and Comparative Example 2.

FIGS. 8a-8c show pictures of sample strings from Comparative Example 1, Comparative Example 2, and Example 1 prior to the Submersion Corrosion Test. FIGS. 8d-8f show pictures of sample strings from Comparative Example 1, Comparative Example 2, and Example 1 after the Submersion Corrosion Test.

FIG. 9 shows a quantitative analysis comparing sample corrosion resistance according to methods described in Submersion Corrosion Testing.

FIG. 10 is a spectrogram comparing the tonal quality of an E-string according to Example 1 with the tonal quality of an E-string according to Comparative Example 2.

FIG. 11 is a spectrogram comparing the tonal quality of an A-string according to Example 1 with the tonal quality of an A-string according to Comparative Example 2.

FIG. 12 is a spectrogram comparing the tonal quality of a D-string according to Example 1 with the tonal quality of a D-string according to Comparative Example 2.

FIG. 13 is a spectrogram comparing the tonal quality of a G-string according to Example 1 with the tonal quality of a G-string according to Comparative Example 2.

FIG. 14 is a spectrogram comparing the tonal quality of an E-string according to Example 2 with the tonal quality of an E-string according to Comparative Example 1.

FIG. 15 is a spectrogram comparing the tonal quality of an A-string according to Example 2 with the tonal quality of an A-string according to Comparative Example 1.

FIG. 16 is a spectrogram comparing the tonal quality of a D-string according to Example 2 with the tonal quality of a D-string according to Comparative Example 1.

FIG. 17 is a spectrogram comparing the tonal quality of a G-string according to Example 2 with the tonal quality of a G-string according to Comparative Example 1.

### DETAILED DESCRIPTION

This disclosure is not meant to be read in a restrictive manner. For example, the terminology used in the application should be read broadly in the context of the meaning those in the field would attribute such terminology. Persons skilled in the art will readily appreciate that various aspects of the present disclosure can be realized by any number of methods and apparatus configured to perform the intended functions. It should also be noted that the accompanying figures referred to herein are not necessarily drawn to scale and may be exaggerated to illustrate various aspects of the present disclosure, and in that regard, the figures should not be construed as limiting.

### Definitions

As used herein, the singular forms “a”, “an”, and “the” include plural reference unless the context clearly dictates otherwise.

As used herein, the term “on” is meant to denote that when an element is “on” another element, it can be directly on the other element or intervening elements may also be present.

As used herein, the terms “about” and “approximately” are understood to mean plus or minus 10% of the stated value.

As used herein, a “spectrogram” is a visual way of representing signal strength (e.g., loudness of a sound) of a signal over time at various frequencies present in a particular waveform. A spectrogram may include time as the x-axis, frequency as the y-axis, and representing the amplitude of the signal by displaying different colors on the graph (e.g., brighter color represents stronger/louder amplitude, darker color represents weaker amplitude). The fundamental frequency is the lowest note on the spectrogram. As harmonics are integer multiples of the fundamental frequency, the fundamental frequency is set to be the first harmonic on the spectrogram. When comparing spectrograms of different samples, the duration of signal at specific frequencies, presence of energy at specific frequencies, decay profile, and brightness comparison at same frequency between string type are all factors taken into consideration for quantifying the tonal quality of a given string sample.

As used herein, “substantially non-damping” is used to describe an acceptable range of diminished tonal quality between a coated string and an uncoated string of the same construction. For methods which measure tonal quality with respect to time, “substantially non-damping” means that the measured difference between a coated and an uncoated string is less than ± about 30%, or ± about 20%, or ± about 10%, or ± about 5%, or ± about 3%, or ± about 2%, or ± about 1%. For methods which measure tonal quality with respect to magnitude, “substantially non-damping” means that the measured difference between a coated and an uncoated string is less than ± about 30%, or ± about 20%, or ± about 10%, or ± about 5%, or ± about 3%, or ± about 2%, or ± about 1%.

As used herein, the elongate body represents the entirety of the core, winding, and polymer cover.

As used herein, the terms “weight percent” or “wt. %” are meant to denote the weight percent of that component based on the total weight percent of the polymer cover. “Wt. %” may be defined as the mass of the component divided by the total mass of the polymer cover multiplied by 100.

The terms “polymer cover” and “PEKK polymer cover” may be used interchangeably herein.

### String Instrument

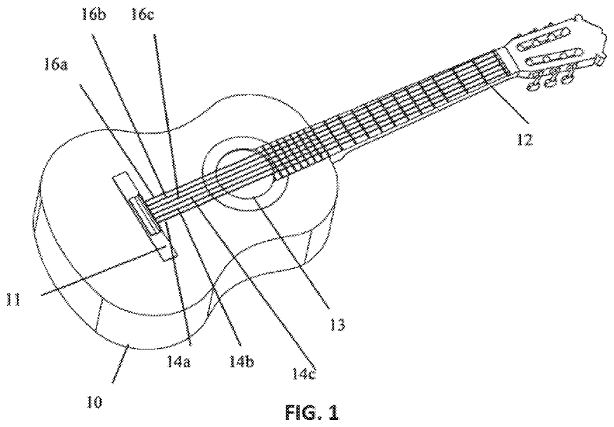

FIG. 1 illustrates an acoustic guitar 10. Although an acoustic guitar is pictured and described herein, it may be understood that the advantages conveyed in this disclosure are equally applicable to other musical instruments containing at least one string (e.g., stringed instruments). The acoustic guitar 10 includes a “fret” or “fingering board” 12, across which multiple strings, 14a, 14b, 14c, 16 a, 16b, and 16c, are strung and against which the strings are pressed to form different notes as the strings are picked or plucked. The acoustic guitar 10 may include three wound strings and three non-wound strings. In certain embodiments, a stringed instrument may include any number of wound strings. As one non-limiting example, all of the strings on a bass guitar may include wound strings (not illustrated).

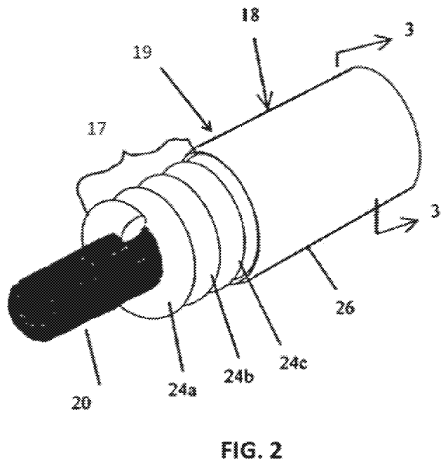

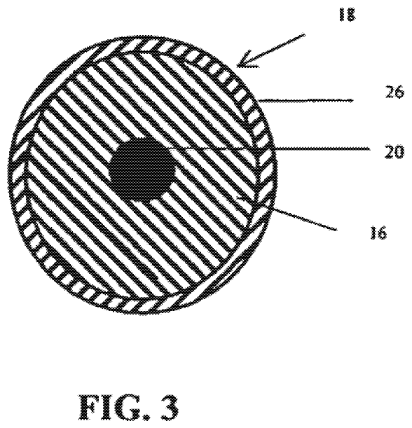

The form of a wound string 16 can be seen inside the string 18 illustrated in FIGS. 2 and 3. As is shown, the string 18 employs a core 20 and a winding 17 wrapped repeatedly around the core 20. The winding 17 is held in place around the core by tension and the anchoring of the winding 17 at its ends.

When a conventional wound string is played for a period of time, it tends to lose its tonal quality due to “contamination” of the string. Contamination in the form of dirt, oil, sweat, etc., tends to become entrapped within the winding, causing limited motion of the individual wraps. This is a particular problem on portions of the string that are frequently touched. As a result, after a period of play, wound strings begin to diminish in tonal quality. Professional musicians who care about tonal quality are then required to remove and replace the wound strings, often on a regular basis, to maintain proper sound. Some of these problems may be addressed if the strings are coated with a substance to avoid contamination of the wound string windings and/or to provide some cushioning or smooth cover for the strings.

FIGS. 2 and 3 illustrate a string 18 that includes a center core 20, a metal winding 17 secured around the core 20, and a polymer cover 26 applied to the wound string 18. The phrase “elongate body” as used herein is meant to denote the combination of the core, the winding, and the polymer cover. The polymer cover 26 contains a polymer material covering the metal winding 17 of the string 18. In some embodiments, the polymer cover 26 may be in the form of one or more tapes, sheets, or tubes that cover the string 18 and protect the string 18 from contamination. In some embodiments, the polymer cover 26 may be applied to the wound string 18 by extruding, enrobing, enveloping, dip coating, powder coating, electrostatic depositing, spray coating, wrapping (e.g., cigarette wrapping or helical wrapping), vapor deposition, brush coating, spin coating, roll coating, or any other method known to those of skill in the art.

The PEKK polymer cover 26 at least partially covers the metal winding 17 along at least a portion of a length of the string 18. In some embodiments, the polymer cover 26 may cover a selected portion(s) of the length of string 18 and leave remaining portions of the length of string 18 uncoated so as to utilize the tactile and acoustic properties of the uncoated string 18 at those regions. In some embodiments, the polymer cover 26 may cover the entire length of string 18.

### Polymer Cover

The polymer cover of the present disclosure includes a polyether-ketone-ketone (PEKK). In some embodiments, the polymer cover 26 is or includes a PEKK polymer. The polymer cover 26 may be configured to produce a sound and feel on the string 18 such that the coated string (i.e., coated with PEKK) sounds and/or feels as though it is uncoated.

The polymer cover 26 may be configured to produce a sound and feel on the string 18 such that the coated string (i.e., coated with PEKK) sounds and/or feels as though it is coated. In such configurations, the PEKK polymer cover may be substantially non-damping to the tonal quality of the elongate body 19. In some embodiments, the PEKK polymer cover changes the damping in a controlled manner.

The polymer cover 26 may preserve the tonal quality and mechanical integrity of the string 18 such that the coated string exhibits a prolonged playable life. By providing an environmental barrier to contamination, a chemical barrier to corrosion, and a mechanical barrier to abrasion, the polymer cover may delay some common factors that induce failure in wound strings.

The polymer cover 26 includes at least 95 wt. % of a PEKK polymer. In certain embodiments, the polymer cover 26 includes at least at least about 90 wt. %, at least about 91 wt. %, at least about 92 wt. %, at least about 93 wt. %, at least about 94 wt. %, at least 95 wt. %, at least about 96 wt. %, at least about 97 wt. %, at least about 98 wt. %, or at least about 99 wt. %, and for each of the foregoing, less than or equal to 100%.

The polymer cover 26 includes a PEKK polymer in an amount from about 90 wt. % to about 100 wt. %, from about 91 wt. % to about 100 wt. %, from about 92 wt. % to about 100 wt. %, from about 93 wt. % to about 100 wt. %, from about 94 % to about 100 wt. %, from about 95 wt. % to about 100 wt. %, from about 96 wt. % to about 100 wt. %, from about 97 wt. % to about 100 wt. %, from about 98 wt. % to about 100 wt. %, from about 99 wt. % to about 100 wt. %, from about 99.9 wt. % to about 100 wt. %, or from about 99.99 wt. % to about 100 wt. %.

The thickness of the polymer cover 26 may be defined in a radial direction perpendicular to a longitudinal center of the string 18. In certain embodiments, the polymer cover 26 may include a thickness from about 1 micron to about 30 microns, from about 1 micron to about 25 microns, from about 1 micron to about 20 microns, from about 1 micron to about 15 microns, from about 1 micron to about 13 microns, from about 2 microns to about 10 microns, from about 3 microns to about 10 microns, from about 4 microns to about 10 microns, from about 5 microns to about 10 microns, from about 5 microns to about 20 microns, from about 7 microns to about 20 microns, from about 10 to about 20 microns, or from about 15 microns to about 20 microns.

In some embodiments, the polymer cover 26 is applied to the string 18 after the metal winding 17 is secured around the core 20. For example, the polymer cover 26 may be attached to the winding 17 after the winding 17 is wrapped around the core 20 so that the polymer cover 26 is applied to an external surface of the winding 17 and form an elongate body 19. In some embodiments, the polymer cover 26 is applied to the metal winding 17 prior to the metal winding 17 being secured around the core 20 such that winding 17 is the external portion of the elongate body 19.

### Tonal Quality

The “tonal quality,” also known as timbre or tone color, refers to the unique sound characteristic of a musical note, sound, or tone that distinguishes it from others, even if they have the same pitch. Tonal quality is largely influenced by the presence and character of overtones above the fundamental frequency. Tonal quality is also influenced by the acoustic bandwidth, or range of frequencies meaningfully present within the signal. Tonal quality allows listeners to differentiate between various sound sources, such as different instruments (e.g., a piano and a violin) or even different versions of the same instrument. The physical characteristics of the instrument and string, such as the material it's made of, its shape, and the way it vibrates, all contribute to the unique tonal quality. Thus, any change to the physical characteristics of the instrument or string may change the tonal quality and acoustic bandwidth of the sound produced by the stringed instrument.

In some embodiments, the tonal quality is partially characterized by peak signal amplitudes within a range of frequencies, and a value may be assigned to represent this characterization. For example, a first value may be assigned to an uncoated string by measuring its peak signal amplitudes between 2,000 Hz and 4,000 Hz and a second value may be assigned to a coated string by measuring its peak signal amplitudes within the same frequency range, when the two strings'vibrations are initiated by equivalent impulses and measured over a shared time domain. The two values may serve as a partial representation of the two strings'tonal qualities and may thus be used to compare the two strings. The signal may be collected and analyzed by common measuring devices known and used by one of ordinary skill in the art. In some embodiments, the tonal quality is partially characterized by the combined frequency response over a wide audible frequency range over a given time domain, and a value may be assigned to represent this characterization. For example, a first value may be assigned to an uncoated string by measuring is frequency response from 4,000 Hz to 20,000 Hz for the first 30 seconds after excitation, and a second value may be assigned to a coated string by measuring its frequency response over the same frequency range and time domain, when the two strings'vibrations are initiated by equivalent impulses. In certain embodiments, the PEKK polymer cover modifies the tonal quality of the string such that the second value is substantially dissimilar from the first value. In some embodiments, the polymer cover enhances an acoustic bandwidth of the string.

In some embodiments, the tonal quality is partially characterized by the rate of attenuation of a specific frequency, and a value may be assigned to represent this characterization. For example, a first value may be assigned to an uncoated string by measuring the time from string excitation to the point at which signal amplitude at 2,000 Hz has decayed by 90% from its maximum value at excitation, and a second value may be assigned to a coated string by measuring the time for it to exhibit the same signal decay at the same frequency, when the two strings'vibrations are initiated by equivalent impulses.

In some embodiments, the PEKK polymer cover 26 is at least partially applied to the winding 17 without the use of an adhesive between metal winding 17 and the polymer cover 26. Current coated instrument string alternatives using a polytetrafluoroethylene (PTFE) or polyethylene (PE) as a covering polymer require an adhesive layer between the coating and the metal winding. The elimination of such an adhesive layer prevents energy losses to internal vibrations within the adhesive layer, which corresponds to reduced damping of tonal quality compared to alternatives that require an adhesive layer.

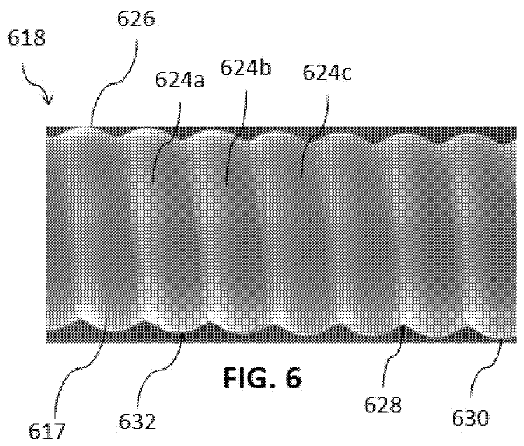

In some embodiments, the PEKK polymer cover 26 conforms to the windings 17, eliminating air pockets between the string and the polymer cover, as shown in FIG. 6. The elimination of air pockets prevents energy losses to internal vibrations of the air in those pockets, which corresponds to reduced damping and/or enhanced acoustic bandwidth compared to alternative methods that do not prevent air pockets between the coating and the winding.

### Abrasion and Corrosion Resistance

The PEKK polymer cover (e.g., polymer cover 26) on a string is both non-abrasive and resistant to corrosion. The abrasion resistance of the PEKK polymer cover can be measured by comparing the initial thickness of the PEKK cover before and after testing. The PEKK covered string demonstrates a minimal change in thickness in the PEKK polymer cover on the string. The change in thickness of the PEKK cover is less than 20%, less than 15%, less than 10%, less than 9%, less than 8%, less than 7%, less than 6%, less than 5%, less than 4%, less than 3%, less than 2%, less than %, and for each of the foregoing, greater than 0% compared to the thickness of the PEKK cover on the string in its original state. The lack of abrasive wear on PEKK covered strings results in a longer lasting cover before any pockets between the windings of the wrapped wire are revealed. Pockets between the windings are points of concentration for contaminants (dirt, oil, sweat, etc.), which add vibration-damping mass to the string. Fewer pockets therefore corresponds to reduced damping of the tonal quality compared to alternative methods that do not prevent the formation of abrasive wear pockets.

The polymer cover 26 also protects the string 18 from corrosion. Tonal quality can be diminished by various environmental factors that cause corrosion of the core or wire wrapping. For example, hot and humid environments can accelerate the corrosion of a metal string, which can be exacerbated by the presence of salts in the sweat of a player's hands as they contact the string. The polymer cover 26 prevents contact between corrosive substances and the wire wrapping.

### Tactile Feel and Shape of the Coated String

Coated instrument strings are often marketed as having a tactile feel that targets specific demographics. For example, some guitar players may prefer “slick” strings with a comfortable feel. The comfortable feel may be caused by a coating on the strings that smooths an external surface of the strings. In contrast, some guitar players prefer a “natural” feel from uncoated guitar strings where the external surface of the strings is bumpy due to the wire winding.

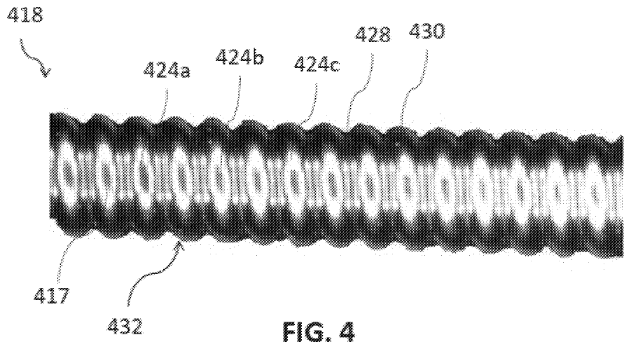

FIG. 4 is a side view of a portion of an uncovered, wound string 418. String 418 includes a winding 417 wrapped repeatedly around a core. The winding 417 includes a plurality of individual wraps 424 (e.g., wraps 424a, 424b, 424c, etc.). The plurality of wraps 424 creates an external surface 432 of string 418 that has a bumpy, undulating shape. The bumpy shape arises due to valleys 428 between each of the individual wraps 424 and crests 430 in the centers of the individual wraps 424. The crests 430 may be located a first average distance away from a longitudinal axis of string 418, and the valleys 428 may be located a second average distance away from a longitudinal axis of string 418. By referring to them as “crests” and “valleys,” it is to be understood that the first average distance is larger than the second average distance. The bumpy shape of the external surface of the string 418 gives the string 418 it's “natural” feel. However, addition of a polymer cover to an instrument string may smooth the external surface of the string. A depth parameter can be calculated which estimates the degree to which the polymer cover conforms to the winding surface. An elongate body with a depth parameter of less than 7% has a polymer cover that is dissimilar from the shape of the windings. An elongate body with a depth parameter of more than 7% has a polymer cover that is increasingly similar to the shape of the windings. The maximum depth parameter as estimated from optical measurements of the external surface of the string is approximately 25%.

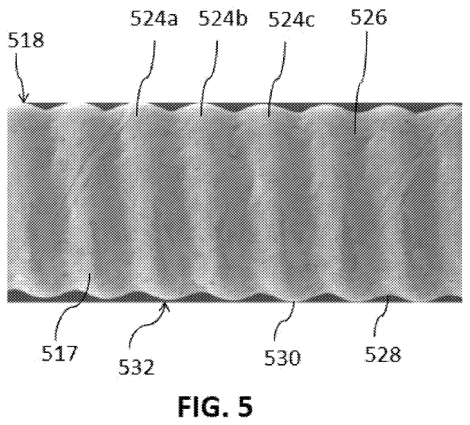

FIG. 5 is a side view of a portion of a covered string 518, according to embodiments herein. As shown, covered string 518 includes a polymer cover 526 forming a shape around the wound string 518 dissimilar to the shape of the winding 517. String 518 includes a winding 517 wrapped repeatedly around a core. The winding 517 includes a plurality of individual wraps 524 (e.g., wraps 524a, 524b, 524c, etc.). The string 518 also includes a polymer cover 526.

The polymer cover 526 has a shape dissimilar to the shape of the winding 517. The polymer cover 526 creates an external surface 532 of string 518 that is relatively smooth compared to a shape defined by an external surface of wraps 524. For example, the external surface 532 of the string 518 as defined by the polymer cover 526 defines crests 530 a first average distance away from a longitudinal axis of the string 518, and valleys 528 a second average distance away from a longitudinal axis of the string 518. A first difference between the first average distance and the second average distance may be smaller than a similarly calculated second difference between the crests and valleys defined solely by the external surface of the wraps 524. The smooth shape of the external surface 532 of the string 518 may give the string 518 its comfortable feel. The depth parameter for string 518 is approximately 7% or less, which means the polymer cover is dissimilar to the shape of the windings.

FIG. 6 is a side view of a portion of a covered string 618, according to embodiments herein. As shown, covered string 618 includes a polymer cover 626 forming a shape around the wound string 618 similar to the shape of the winding 617. String 618 includes a winding 617 wrapped repeatedly around a core. The winding 617 includes a plurality of individual wraps 624 (e.g., wraps 624a, 624b, 624c, etc.). The polymer cover 626 has a shape substantially similar to the shape of the winding 617. The polymer cover 626 creates an external surface 632 of string 618 that conforms closely to a shape defined by an external surface of wraps 624. For example, the external surface 632 of the covered string 618 as defined by the polymer cover 626 defines crests 630 a first average distance away from a longitudinal axis of the string 618, and valleys 628 a second average distance away from a longitudinal axis of the string 618. A first difference between the first average distance and the second average distance may be substantially similar to a similarly calculated second difference between the crests and valleys defined solely by the external surface of the polymer cover 626. Because the polymer cover 626 may conform closely to the bumpy shape defined by an external surface of the polymer cover, the external surface 632 of the string 618 may also feel bumpy, and thus having a shape and tactile feel similar to an uncoated string. The depth parameter for string 618 is approximately 7% or greater, resulting in a polymer cover more conformed to the winding wire and giving the string a feel closer to an uncoated string when compared to string 518.

The tactile feel and tonal quality of the coated strings of the present disclosure can be tailored to a variety of consumer preferences more effectively than conventional materials. Currently, ePTFE and ePE materials used for string coatings require changes in physical properties of the pre-processed polymer film in order to change the resulting characteristics of the string. In contrast, a PEKK polymer can be manipulated during processing to conform to the string in different ways to change the tonal quality and tactile feel of the string.

In some embodiments, at least one string of a stringed musical instrument includes a core, a winding secured around the core, and a polymer cover that includes at least 95 wt. % of a poly(ether ketone ketone) (PEKK) polymer at least partially covering the winding. The polymer cover at least partially covers the winding without the use of an adhesive between the polymer cover and the winding. In some embodiments, the polymer cover has a shape substantially similar to the shape of the core. In some embodiments, the polymer cover has a shape dissimilar to the shape of the core.

### Method of Forming

A method of making a PEKK covered string includes a string of a musical instrument that has a core (e.g., core 20 of FIG. 2), a metal winding (e.g., winding 17 of FIG. 2) secured around the core, and a PEKK polymer cover (e.g., polymer cover 26 of FIG. 2). An elongate body (e.g., elongate body 19) is used herein to designate the combination of features that form the string of a musical instrument. Examples of stringed musical instruments include guitars, violins, violas, pianos, cellos, harps, banjos, mandolins, ukeleles, etc.

The method may also include at least partially covering the winding with a PEKK polymer film (e.g., polymer cover 26) to form an elongate body. In some embodiments, the polymer cover may have a physical format including, but not limited to, one or more of films, tapes, sheets, or tubes that covers at least a portion of a length of the string. In some embodiments, the method may include applying the polymer cover over the metal winding after the winding is secured around the core. In some embodiments, the method may include applying the polymer cover to the winding prior to the winding being secured around the core. In some embodiments, the method may include applying the polymer cover to the core prior to the winding being secured around the core.

The method may further include heating the wrapped elongate body to secure the PEKK polymer onto the metal winding to form an elongate body that is at least partially covered by a polymer cover. In some embodiments, the method includes heating the elongate body to a temperature from about 200° C. to about 400° C. to secure the PEKK polymer cover onto the winding. The heating step may be performed at one or more durations.

### Test Methods

### Pick-O Testing

Pick-O Testing is used to measure the abrasion resistance (e.g., durability) of a string using an apparatus designed to pick a sample guitar string in the same place and in a repeatable fashion. The secured sample string is picked at least 1000 times at the same place for a designated period of time. Over time, the surface of the polymer covered string is gradually abraded. This causes a change in the surface topography, of the string. The average roughness of each sample is recorded and compared to the initial average surface roughness. For each sample, surface roughness on the order of <1 μm to 80 μm is recorded. The percent difference between the roughness of abraded samples and that of unabraded controls is recorded as Change in Roughness (ΔRa_avg), which is used to quantify the abrasion resistance of a sample string.

### Tonal Quality Measurement and Analysis

Audio samples were captured using methods commonly used by one of skill in the art. The audio samples were analyzed to understand the tonal quality in temporal and temporal-spectral domain.

### Crossover Corrosion Testing

Guitar strings corrode due to a combination of moisture and ions present in the sweat of players. The ability of a film to prevent corrosion can be assessed by evaluating its efficacy as an ion barrier using H-cells in a manner to test ion transport.

### Submersion Corrosion Testing

A more application-based assessment of corrosion resistance can be achieved by submerging strings in an acidic solution prepared in accordance with ISO 3160-2. Visual inspection of the strings is initially conducted to qualitatively assess the corrosion resistance of various sample strings (e.g., with different covers, or with no cover).

For a quantitative comparison of the Submersion Corrosion Test results, images are taken of a 3 in section of each submerged sample using an optical scope. The number of winds present in the image is recorded. The number of winds that are visually determined to have been affected by corrosion are recorded, and the quantification of corrosive severity is presented as the ratio of affected winds to total winds, Affected String Area (%).

### Thickness

The thickness of the PEKK polymer cover is measured using a noncontact optical profilometer, using standard profilometry procedures and methodologies. Thickness is calculated using measurements from the top of the cover, the top of the string, and a correction factor based on the density of the material.

### Depth Parameter

The depth parameter is a way to characterize the profile of the polymer cover relative to the winding wire. It provides an estimate of how similar or dissimilar the polymer cover is to the winding wire profile. It is calculated by measuring the distance between the valley created by polymer cover between windings and the crest of the outer surface of the adjacent winding. This distance is then divided by the nominal radius of the string. The upper limit of the valley created by polymer cover conforming to the shrinking is dictated by the geometry of the winding wire. The winding wire size changes depending on the overall diameter of the string. For that reason, the polymer cover valley depth is normalized by string radius, resulting in the depth parameter. For example, a string with the film coating just contacting the crest of the windings and not creating any valleys between would have a depth parameter of 0%. In another example, a 1.35 mm diameter string with a polymer cover valley depth of . 0832mm would have a depth parameter of 12.4%. Due to processing variability along the length of the string, the depth parameter may vary slightly within a given string.

### EXAMPLES

### Comparative Example 1—Uncoated String

Uncoated Phosphor Bronze strings were used as Comparative Example 1 in the Examples set forth below.

### Comparative Example 2—String With Ptfe Coating

Strings coated with ePTFE polymer (Elixir® Strings Acoustic Phosphor Bronze with NANOWEB® Coating) were used as Comparative Example 2 in the Examples set forth below.

### Example 1—String With PEKK Coating

Wound strings of four types (E, A, D, G strings of an acoustic guitar) were coated with a PEKK polymer cover under the following conditions in Example 1. Each string was contained cores and windings secured around the cores. The strings used were 0.61 mm, 0.81 mm, 1.07 mm, and 1.35 mm diameter Phosphor Bronze uncoated strings. The strings were at least partially wrapped with a PEKK polymer film to form wrapped elongate bodies. The wrapped elongate bodies were baked until the elongate body reached the glass transition temperature for this polymer.

### Example 2—String With PEKK Coating

Wound strings of four types (E, A, D, G) were coated with a PEKK coating. The strings were provided with elongate bodies, including cores and windings secured around the cores. The strings used were 0.61 mm, 0.81 mm, 1.07 mm, 1.35 mm Phosphor Bronze uncoated strings. The strings were at least partially wrapped with a polymer film including PEKK to form wrapped elongate bodies. The strings were at least partially wrapped with a PEKK polymer film to form wrapped elongate bodies. The wrapped elongate bodies were baked until the elongate body reached the melt temperature for this polymer.

### Example 3—Abrasion Resistance Comparison

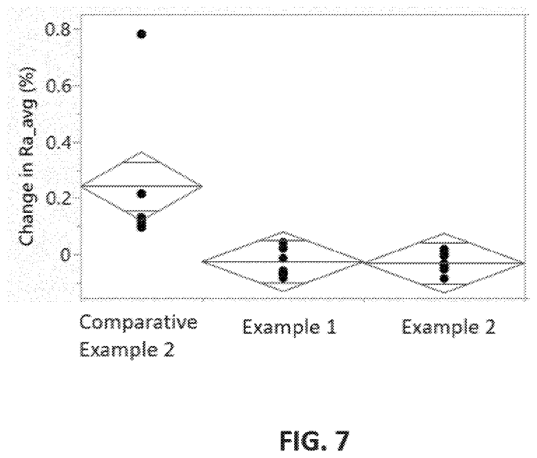

Example 3 compares abrasion resistance of 0.042-gauge (D) string samples from Example 1 and 2 with Comparative Example 2. FIG. 7 shows means of Average Change in Roughness (change in Ra_{avg}) data collected and calculated according to the Pick-O Test Method for Example 1, Example 2, and Comparative Example 2. As shown, both Example 1 and Example 2 with PEKK polymer covers have significantly lower change in roughness than Comparative Example 2 with PTFE polymer cover. The estimated mean change in roughness was 24.18% for Comparative Example 2, −2.49% for Example 1, and −3.04% for Example 2.

### Example 4—Corrosion Resistance Comparison

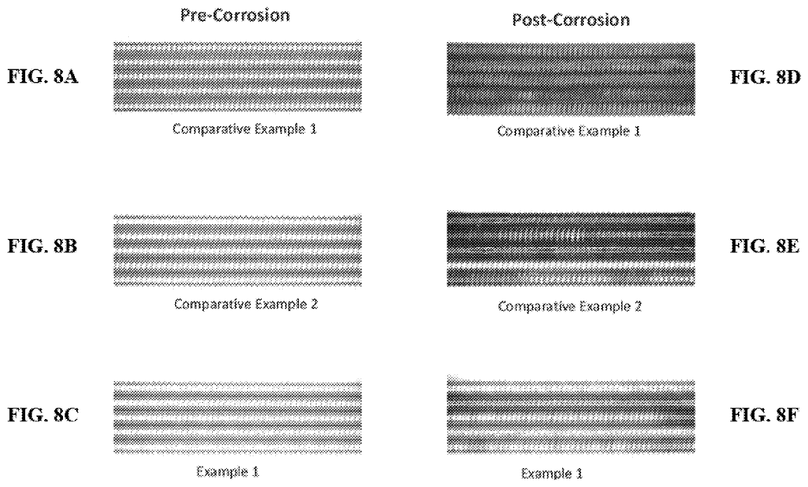

Example 4 compares corrosion resistance of samples from Comparative Examples 1 and 2 with Example 1. FIGS. 8a-8c show pictures of sample strings from Comparative Example 1, Comparative Example 2, and Example 1 prior to the Submersion Corrosion Test. FIGS. 8d-8f show pictures of sample strings from Comparative Example 1, Comparative Example 2, and Example 1 after the Submersion Corrosion Test. A visual inspection was conducted for qualitative assessment of the corrosion resistance of each sample, and the PEKK polymer coated strings from Example 2 demonstrated much better corrosion resistance than Comparative Example 1 without coating and Comparative Example 2 with PTFE coating.

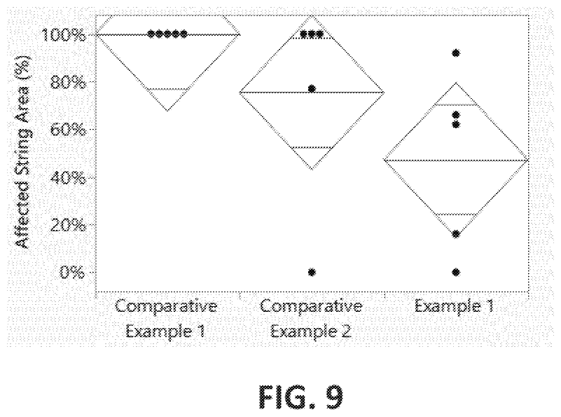

A quantitative analysis comparing each sample's corrosion resistance was also conducted according to methods described in Submersion Corrosion Testing, with data shown in FIG. 9. As shown in FIG. 9, Example 1 strings with PEKK polymer cover have a significantly lesser affected string area, showing better corrosion resistance than both of the Comparative Examples. The estimated mean affected string area was 47.2% for Example 1, 100% for Comparative Example 1, and 75.4% for Comparative Example 2.

### Example 5—Tonal Quality Comparison of Example 1 and Comparative Example 2

Example 5 compares tonal qualities of samples from Example 1 with Comparative Example 2.

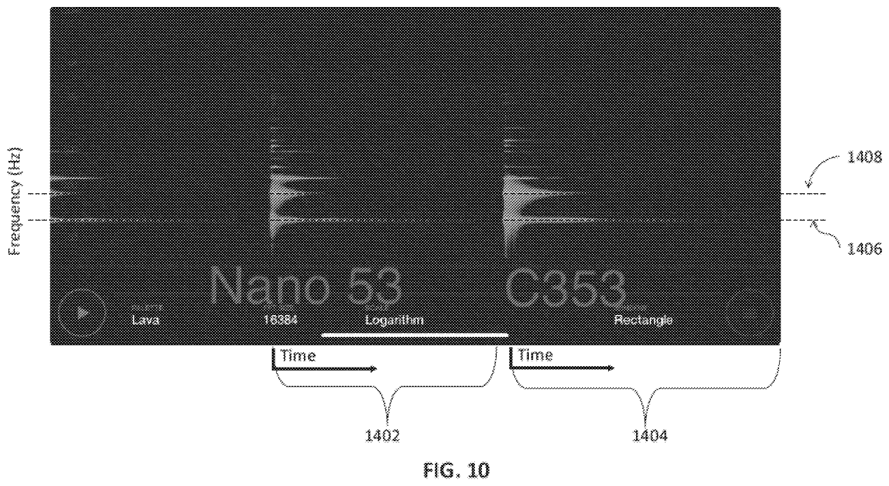

FIG. 10 is a spectrogram comparing the tonal quality of an E-string according to Example 1 with the tonal quality of an E-string according to Comparative Example 2. An E-string on a guitar has a fundamental frequency of about 82.4 Hz. The spectrogram shows a set of Example 1 signals 1404 and a set of Comparative Example 2 signals 1402. The set of Example 1 signals 1404 exhibit significantly more energy and slower decay at both the fundamental frequency 1406 and the first harmonic 1408 than the set of Comparative Example 2 signals 1402.

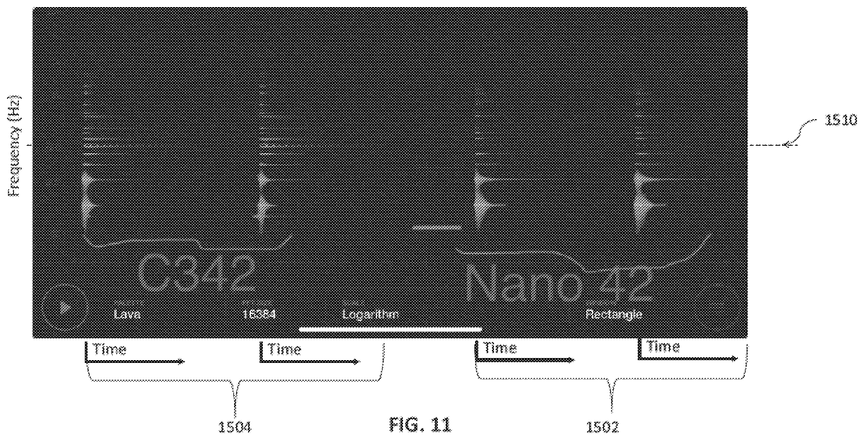

FIG. 11 is a spectrogram comparing the tonal quality of an A-string according to Example 1 with the tonal quality of an A-string according to Comparative Example 2. An A-string on a guitar has a fundamental frequency of about 110 Hz. The spectrogram shows a set of Example 1 signals 1504 and a set of Comparative Example 2 signals 1502. The set of Example 1 signals 1504 exhibit significantly more energy and slower decay at the fifth harmonic 1510 than the set of Comparative Example 2 signals 1502.

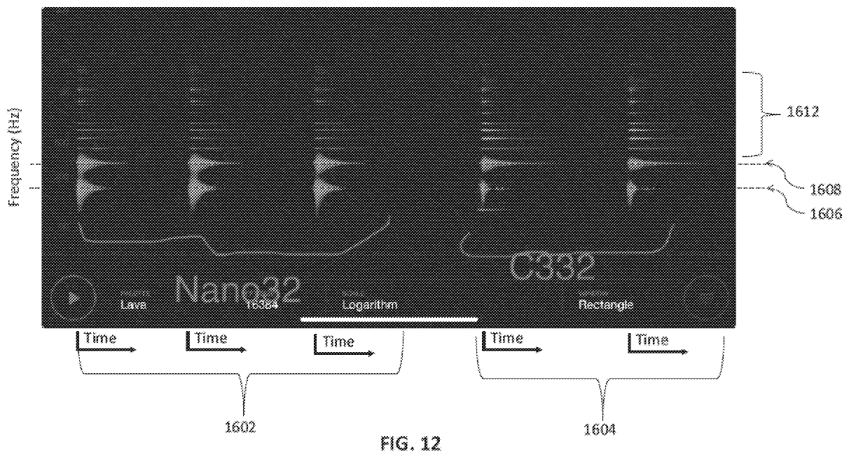

FIG. 12 is a spectrogram comparing the tonal quality of a D-string according to Example 1 with the tonal quality of a D-string according to Comparative Example 2. A D-string on a guitar has a fundamental frequency of about 146.8 Hz. The spectrogram shows a set of Example 1 signals 1604 and a set of Comparative Example 2 signals 1602.

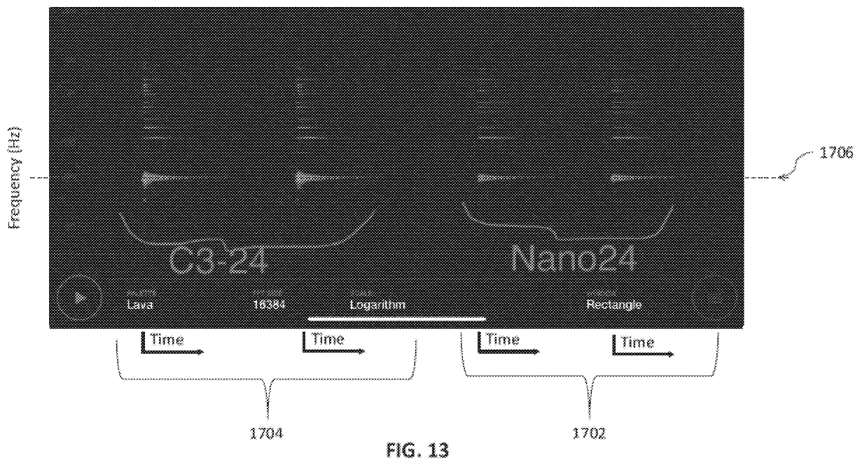

FIG. 13 is a spectrogram comparing the tonal quality of a G-string according to Example 1 with the tonal quality of a G-string according to Comparative Example 2. A G-string on a guitar has a fundamental frequency of about 196 Hz. The spectrogram shows a set of Example 1 signals 1704 and a set of Comparative Example 2 signals 1702. The set of Example 1 signals 1704 exhibit more energy at the fundamental frequency 1706 than the set of Comparative Example 2 signals 1402.

### Example 6—Tonal Quality Comparison of Example 2 and Comparative Example 1

Example 6 compares tonal qualities of samples from Example 2 with Comparative Example 1.

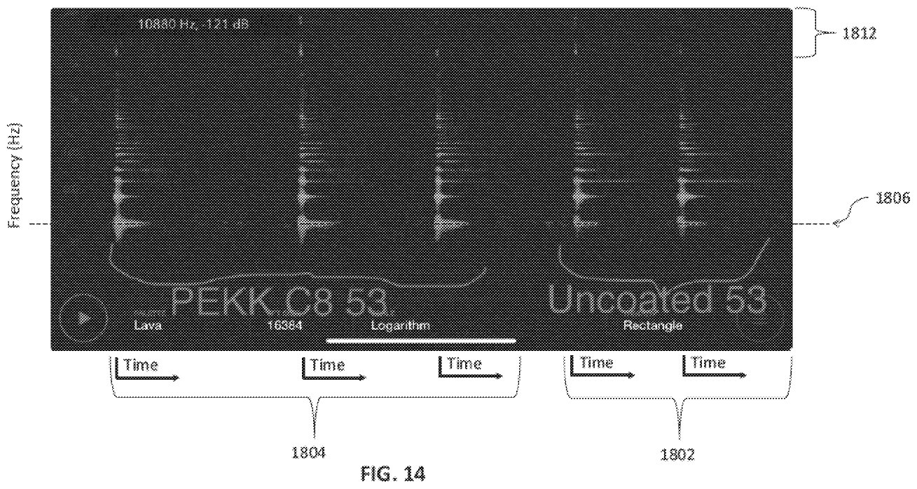

FIG. 14 is a spectrogram comparing the tonal quality of an E-string according to Example 2 with the tonal quality of an E-string according to Comparative Example 1. An E-string on a guitar has a fundamental frequency of about 82.4 Hz. The spectrogram shows a set of Example 2 signals 1804 and a set of Comparative Example 1 signals 1802. The set of Example 2 signals 1804 exhibit more energy and slower decay at the fundamental frequency 1806 than the set of Comparative Example 1 signals 1802. The set of Example 2 signals 1804 also exhibit more energy in the harmonics between 4k and 20k Hz 1812 than the set of Comparative Example 1 signals 1802.

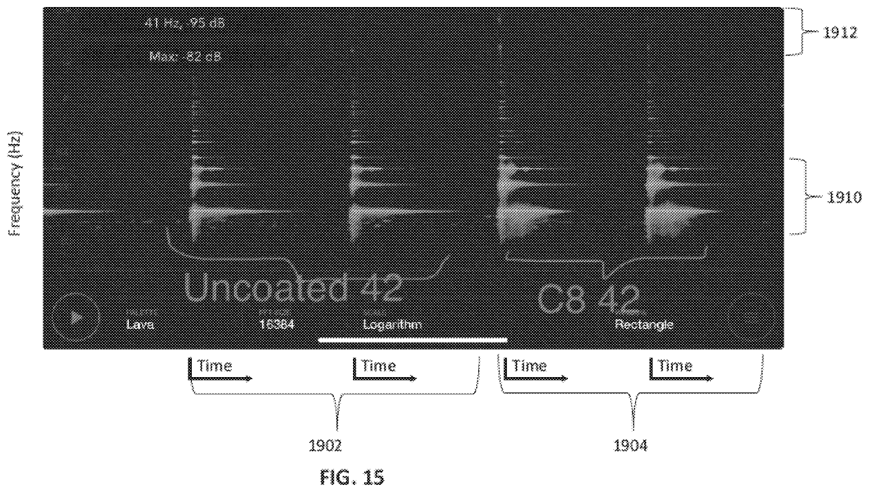

FIG. 15 is a spectrogram comparing the tonal quality of an A-string according to Example 2 with the tonal quality of an A-string according to Comparative Example 1. An A-string on a guitar has a fundamental frequency of about 110 Hz. The spectrogram shows a set of Example 2 signals 1904 and a set of Comparative Example 1 signals 1902. The set of Example 2 signals 1904 exhibit more energy and slower decay at the fundamental frequency and first few harmonics 1910 than the set of Comparative Example 1 signals 1902. The set of Example 2 signals 1904 also exhibit more energy in the harmonics between 4,000 Hz and 20,000 Hz 1912 than the set of Comparative Example 1 signals 1902.

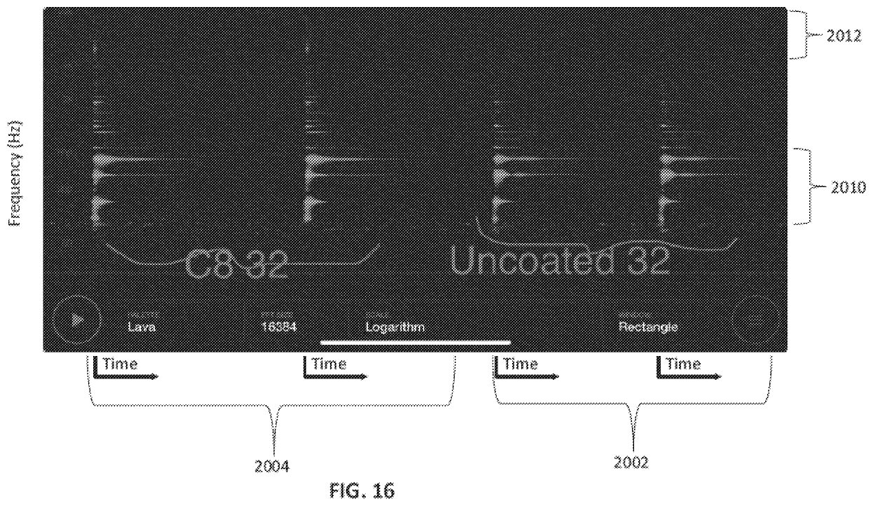

FIG. 16 is a spectrogram comparing the tonal quality of a D-string according to Example 2 with the tonal quality of a D-string according to Comparative Example 1. A D-string on a guitar has a fundamental frequency of about 146.8 Hz. The spectrogram shows a set of Example 2 signals 2004 and a set of Comparative Example 1 signals 2002. The set of Example 2 signals 2004 exhibit more energy and slower decay at the fundamental frequency and first few harmonics 2010 than the set of Comparative Example 1 signals 2002. The set of Example 2 signals 2004 also exhibit more energy in the harmonics between 4k and 20k Hz 2012 than the set of Comparative Example 1 signals 2002. 2012 shows the enhanced acoustic bandwidth of signal 2004 compared to signal 2002.

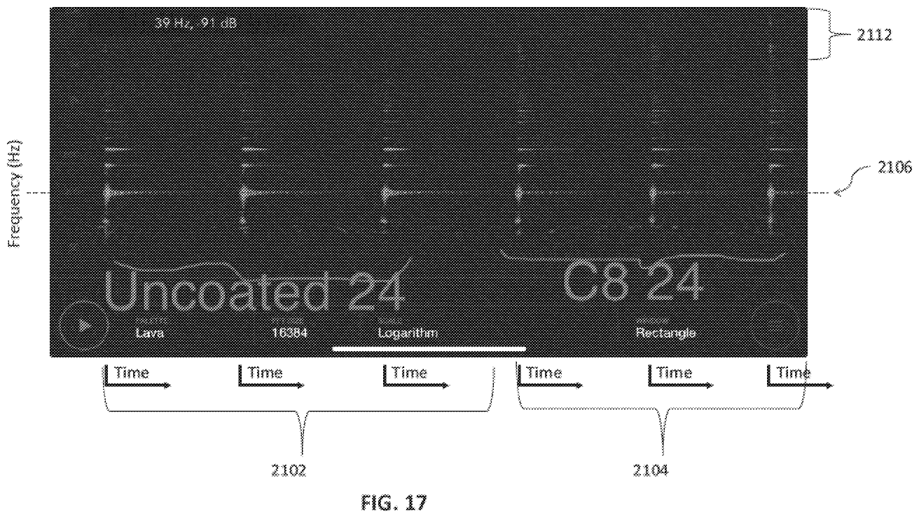

FIG. 17 is a spectrogram comparing the tonal quality of a G-string according to Example 2 with the tonal quality of a G-string according to Comparative Example 1. A G-string on a guitar has a fundamental frequency of about 196 Hz. The spectrogram shows a set of Example 2 signals 2104 and a set of Comparative Example 1 signals 2102. The set of Example 2 signals 2104 exhibit less energy at the fundamental frequency 2106 than the set of Comparative Example 1 signals 2102. However, the set of Example 2 signals 2104 exhibit more energy in the harmonics between 4k and 20k Hz 2112 than the set of Comparative Example 1 signals 2102.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

What is claimed is:

1. A string of a musical instrument, the string comprising:
an elongate body including a core and a winding secured around the core, wherein the elongate body is characterized by a tonal quality having a first value; and
a polymer cover containing at least 95 wt. % of a poly(ether ketone ketone) (PEKK) polymer, the PEKK polymer at least partially covering an outer surface of the winding such that the tonal quality of the elongate body is characterized by a second value.

2. The string of claim 1, wherein the polymer cover has a shape substantially similar to the shape of the winding.

3. The string of claim 1, wherein the polymer cover has a shape dissimilar to the shape of the winding.

4. The string of claim 1, wherein the polymer cover is applied to the winding after the winding is secured around the core.

5. The string of claim 1, wherein the polymer cover is applied to the winding prior to the winding being secured around the core.

6. The string of claim 1, wherein the polymer cover modifies the tonal quality of the elongate body such that the second value is substantially dissimilar from the first value.

7. The string of claim 1, wherein the first value and the second value have similar signal amplitudes at frequencies from about 4,000 Hz to about 20,000 Hz and the tonal quality of the elongate body is not substantially damped.

8. The string of claim 1, wherein the polymer cover enhances an acoustic bandwidth of the elongate body.

9. The string of claim 1, wherein the polymer cover preserves the tonal quality of the elongate body without substantially changing the first value.

10. The string of claim 1, wherein the polymer cover substantially changes the tonal quality of the first value.

11. The string of claim 1, wherein the polymer cover is substantially non-damping to the tonal quality of the elongate body.

12. The string of claim 1, wherein the polymer cover changes the damping in a controlled manner.

13. The string of claim 1, wherein the polymer cover protects the elongate body from corrosion.

14. The string of claim 1, wherein the polymer cover at least partially covers the winding without use of an adhesive between the winding and the polymer cover.

15. The string of claim 1, wherein the polymer cover has a thickness from about 1 micron to about 30 microns.

16. A method comprising:
providing a string of a musical instrument, the string having a first elongate body including a core and a winding around the core, wherein the elongate body is characterized by a tonal quality having a first value;
at least partially covering the winding with a poly(ether ketone ketone) (PEKK) polymer to form a second elongate body; and
heating the second elongate body to a temperature from about 200° C. to about 400° C. to secure the PEKK polymer onto the winding and form a second elongate body characterized by a tonal quality having a second value.

17. The method of claim 16, wherein the polymer cover is substantially non-damping to the tonal quality of the elongate body.

18. The method of claim 16, wherein the polymer cover enhances an acoustic bandwidth of the elongate body.

19. The method of claim 16, wherein the polymer cover on the second elongate body has a thickness from about 1 micron to about 30 microns.

20. The method of claim 16, comprising applying the polymer cover to the winding after the winding is secured around the core.

21. The method of claim 16, comprising applying the polymer cover to the winding prior to the winding being secured around the core.

22. A string of a musical instrument comprising:
a core;
a winding secured around the core; and
a polymer cover containing at least 95 wt. % of a poly(ether ketone ketone) (PEKK) polymer.
